(19) United States
(12) Patent Application Publication
(10) Pub. No.: US 2013/0247065 A1
(43) Pub. Date: Sep. 19, 2013

(54) APPARATUS AND METHOD FOR EXECUTING MULTI-OPERATING SYSTEMS

(71) Applicant: SAMSUNG ELECTRONICS CO., LTD., Suwon-si (KR)

(72) Inventors: Seung Won Lee, Hwaseong-si (KR); Yong Sam Shin, Hwaseong-si (KR); Shi Hwa Lee, Seoul (KR)

(73) Assignee: SAMSUNG ELECTRONICS CO., LTD., Suwon-si (KR)

(21) Appl. No.: 13/795,958

(22) Filed: Mar. 12, 2013

(30) Foreign Application Priority Data
Mar. 16, 2012 (KR) 10-2012-0026964

(51) Int. Cl. G06F 9/50

(52) U.S. Cl. CPC G06F 9/50
USPC 718/104

(57) ABSTRACT

An apparatus and method for executing multi-operating systems (OS) are provided. Resources allocated to the respective multi-OSs are managed by management applications of the multi-OSs. A processor executes a plurality of multi-OSs. Each of the plurality of multi-OSs executes the management application. Each of the plurality of multi-OSs regards a resource held by another multi-OS among the plurality of multi-OSs as used by the corresponding management application, thereby preventing the resource from being allocated to another application included in the multi-OS.

### CROSS-REFERENCE TO RELATED APPLICATIONS

This application claims the priority benefit of Korean Patent Application No. 10-2012-0026964, filed on Mar. 16, 2012, in the Korean Intellectual Property Office, the disclosure of which is incorporated herein by reference.

### BACKGROUND

1. Field

One or more example embodiments of the following description relate to an apparatus and method for executing multi-operating systems, and more particularly, to an apparatus and method for managing resources allocated to multi-operating systems using a management application.

2. Description of the Related Art

A most widely used method for improving performance of a computer system is to increase a number of processors or processor cores of the computer system.

As multi-core systems are popularized, a plurality of applications are generally applied by dividing a plurality of cores.

Under the multi-core environment, it may be more efficient to selectively use various operating systems (OSs) in managing various applications than to manage all of various applications by a single OS. When the OS is used corresponding to the application, resources may be more efficiently used. Here, the resources may include power, a central processing unit (CPU), and the like.

### SUMMARY

The foregoing and/or other aspects are achieved by providing an electronic apparatus including a processor to execute a plurality of operating systems (OSs), and a device, wherein a first OS of the plurality of OSs executes a management application and the first OS regards a resource of the electronic apparatus, held by a second OS of the plurality of OSs, as being used by the management application, when the resource is held by the second OS, and the resource corresponds to the device.

The plurality of OSs may use the same configuration information with respect to hardware included in the electronic apparatus.

The plurality of OSs may include at least one selected from an audio/video (A/V)-oriented OS designed for processing audio data and video data and a network-oriented OS designed for networking.

A resource holding state of the plurality of OSs may be changed by communication between the management applications.

Each of a first OS and a second OS may be one OS of the plurality of Oss.

The first OS may hold a first resource in such a manner that a management application of the first OS requests the first resource from the second OS holding the first resource.

The first resource may be used exclusively by one OS of the plurality of OSs.

A first OS may be one OS of the plurality of OSs and a second OS may be one OS of remaining OSs except the first OS among the plurality of Oss.

The first OS may release holding of a first resource in such a manner that a management application of the first OS returns the first resource to a management application of the second OS.

The first OS may start use of a second resource in such a manner that a management application of the first OS sets an interrupt of the second resource to be transmitted to the first OS.

The first OS may end use of the second resource in such a manner that the management application of the first OS sets the interrupt of the second resource to be not transmitted to the first OS.

The second resource may include a resource sharable by at least one OS among the plurality of OSs.

The processor may include a plurality of cores, and each of the plurality of cores may execute one OS of the plurality of OSs.

The foregoing and/or other aspects are also achieved by providing an operation method of an electronic apparatus that includes a processor and executes a plurality of OSs, the operation method including the processor executing the plurality of OSs, and a first OS of the plurality of OSs executing a management application, wherein the first OS of the plurality of OSs regards a resource of the electronic apparatus, held by a second OS of the plurality of OSs, as being used by the management application when the resource is held by the second OS.

The operation method may further include the plurality of OSs reading in the same configuration information with respect to hardware included in the electronic apparatus.

The operation method may further include a resource holding state of the plurality of OSs being changed by the management application.

The changing of the resource holding state may include the first OS holding a first resource in such a manner that a management application of the first OS requests the first resource from the second OS holding the first resource.

Each of the first OS and the second OS may be one OS of the plurality of OSs.

The first resource may be used exclusively by one OS of the plurality of OSs.

The changing of the resource holding state may include the first OS releasing holding of a first resource in such a manner that a management application of the first OS returns the first resource to a management application of the second OS.

The first OS may be one OS of the plurality of OSs and the second OS is one OS of remaining OSs except the first OS among the plurality of OSs.

The changing of the resource holding state may include the first OS starting use of a second resource in such a manner that a management application of the first OS sets an interrupt of the second resource to be transmitted to the first OS, and the first OS ending use of the second resource in such a manner that the management application of the first OS sets the interrupt of the second resource to be not transmitted to the first OS.

The foregoing and/or other aspects are achieved by providing an electronic apparatus. The electronic apparatus includes a plurality of operating systems (OSs) comprising a first OS and a second OS that is different than the first OS, wherein the first OS executes a first management application, a processor to execute the plurality of operating systems (OSs); and, a resource corresponding to a device, wherein when the resource corresponding to the device is allocated to the second OS, the first OS may set the resource as allocated to the first management application thereby preventing the resource from being allocated to other applications being executed on the first OS.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 is a diagram illustrating a structure of an electronic apparatus executing a plurality of operating systems (OSs) according to example embodiments;

FIG. 2 is a diagram illustrating operations of a plurality of OSs according to example embodiments;

FIG. 3 is a diagram illustrating a use method of a memory of a management application according to example embodiments;

FIG. 4 is a diagram illustrating a use method of a network device of a management application according to example embodiments; and

FIG. 5 is a flow illustrating an operation method of an electronic apparatus, according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

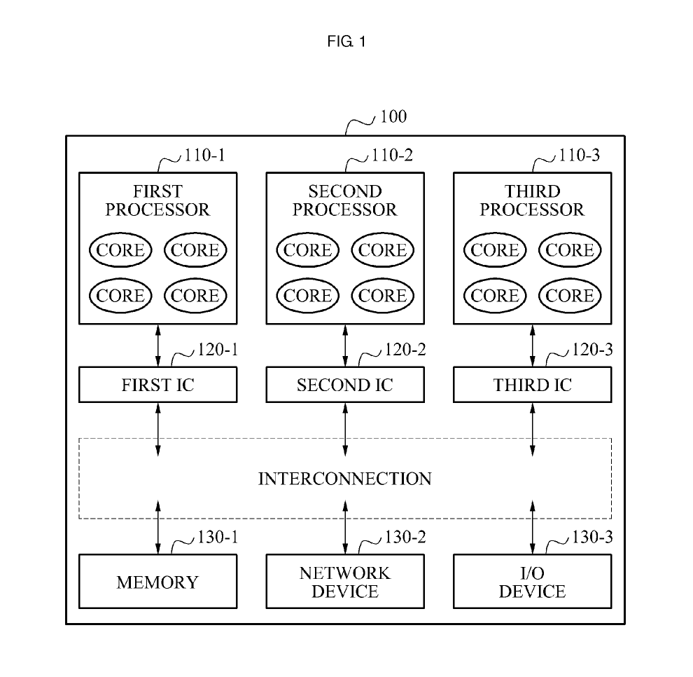

FIG. 1 illustrates a structure of an electronic apparatus 100 executing a plurality of operating systems (OSs) according to example embodiments.

The electronic apparatus 100 may include, for example, at least one processor, at least one interrupt controller (IC), and at least one device. Here, the electronic apparatus 100 may include an information processing apparatus such as a server, a personal computer (PC), a smart phone, and the like.

In FIG. 1, a memory 130-1, a network device 130-2, and an input/output (I/O) device 130-3 are illustrated as corresponding to the at least one device.

In FIG. 1, a first processor 110-1, a second processor 110-2, and a third processor 110-3 are illustrated as corresponding to the at least one processor.

Each of the at least one processor may include at least one core. In FIG. 1, the first processor 110-1, the second processor 110-2, and the third processor 110-3 each include four cores, although other quanties of cores are equally possible.

The at least one IC may include a generic IC. One IC may be provided to each of a plurality of processors. FIG. 1 shows a first IC 120-1, a second IC 120-2, and a third IC 120-3 respectively corresponding to the first processor 100-1, the second processor 100-2, and the third processor 100-3.

A processor or a core of the processor may be connected to a device through an interconnection, as illustrated in FIG. 1.

An IC may control transmission of an interrupt between processors, or between a core and a processor. The IC may transmit an interrupt generated from a device, one processor among a plurality of processors, or one core of a processor, to another processor among the plurality of processors or to another core of the processor. For example, the first IC 110-1 may transmit an interrupt generated from the network device 130-2 to a first core of the first processor 100-1.

Each processor or each core of a processor may set whether to receive an interrupt generated in a particular device. According to the setting of each individual device, a particular processor or core may receive the interrupt generated from the particular device along with another processor or core, or may not receive the interrupt.

The processor may execute a plurality of OSs.

When there are a plurality of processors, the plurality of processors may each execute one OS among the plurality of OSs. At least one processor among the plurality of processors may be allocated to each of the plurality of OSs.

When the processor includes a plurality of cores or when each of the plurality of processors includes a plurality of cores, each of the plurality of cores may execute one OS among the plurality of OSs. That is, at least one core among the plurality of cores may be allocated to each of the plurality of OSs.

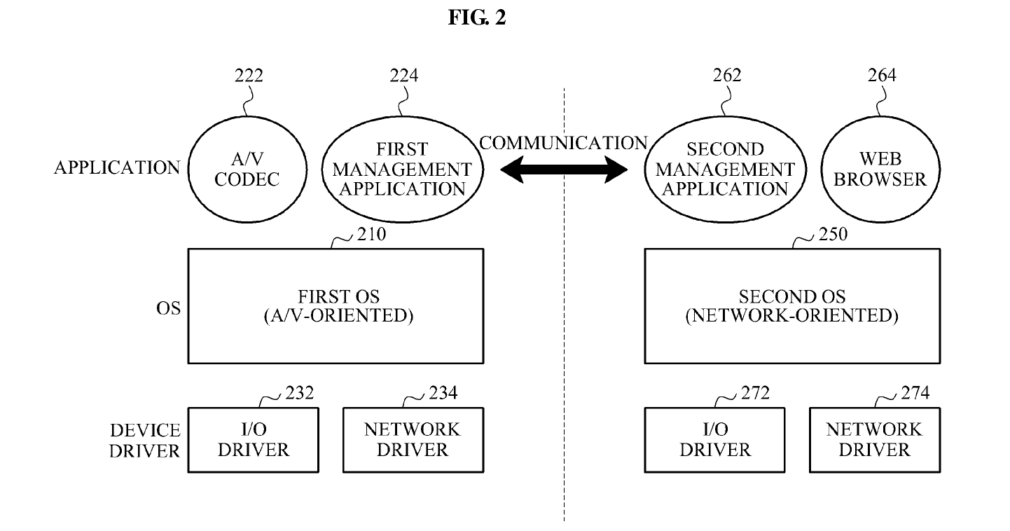

FIG. 2 illustrates operations of a plurality of OSs according to example embodiments.

In FIG. 2, a first OS 210 and a second OS 250 are shown as an example of the plurality of OSs.

The first OS 210 may be an audio/video (A/V)-oriented OS designed appropriate for processing of audio data and video data. The second OS 250 may be a network-oriented OS designed appropriate for networking. That is, the plurality of OSs may include at least one of the A/V-oriented OS and the network-oriented OS, although other types of OSs are equally available.

An I/O driver 232 and a network driver 234 are shown as drivers for access of the first OS 210 to the device. In addition, an I/O driver 272 and a network driver 274 are shown as drivers for access of the second OS 250 to the device.

The plurality of OSs may execute various applications, respectively. Also, the plurality of OSs may each execute a respective management application.

As an example with respect to the first OS 210 and the second OS 250, an A/V codec 222 and a first management application 224 executed on the first OS 210 and a second management application 262 and a web browser 264 executed on the second OS 250 are shown. The first management application 224 is a management application executed by the first OS 210. The second management application 262 is a management application executed by the second OS 250.

Each of the plurality of OSs may determine that a resource of the electronic apparatus 100, which is held by another OS, is used by a management application of the another OS. Here, the resource may refer to a hardware resource that corresponds to one device of the at least one device included in the electronic apparatus 100.

For example, when a resource corresponding to a particular device of the electronic apparatus 100 is not allocated to the first OS 210, the first OS 210 may set the resource as being allocated to the first management application 224. Therefore, the first OS 210 may prevent the resource from being allocated to other applications being executed on the first OS 210. The first management application 224 may notify the first OS 210 of a resource allocated to the second OS 250. In the first OS 210, which is the A/V-oriented OS, the first management application 224 may be an application indicating the resource allocated to the second OS 250, which is the network-oriented OS. Accordingly, the first management application 224 may be referred to as a network-oriented OS (NOS) application in the first OS 210.

When a resource corresponding to a particular device of the electronic apparatus 100 is not allocated to the second OS 250, the second OS 250 may set the resource as being allocated to the second management application 262. Therefore, the second OS 250 may prevent the resource from being allocated to other applications being executed on the second OS 250. The second management application 262 may notify the second OS 250 of a resource allocated to the first OS 210. In the second OS 250, which is the network-oriented OS, the second management application 262 may be an application indicating the resource allocated to the first OS 210, which is the A/V-oriented OS. Accordingly, the second management application 262 may be referred to as an A/V-oriented OS (AOS) application in the second OS 250.

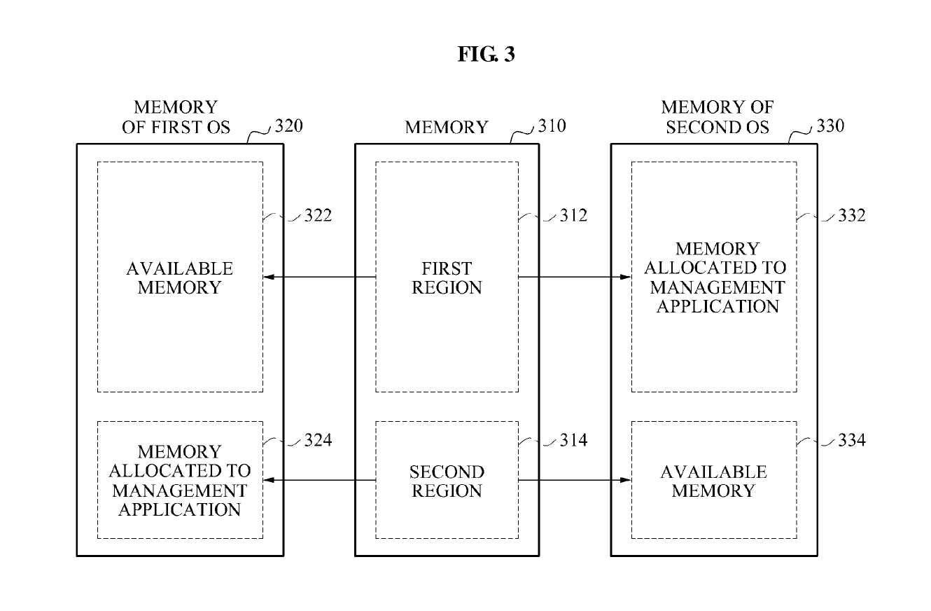

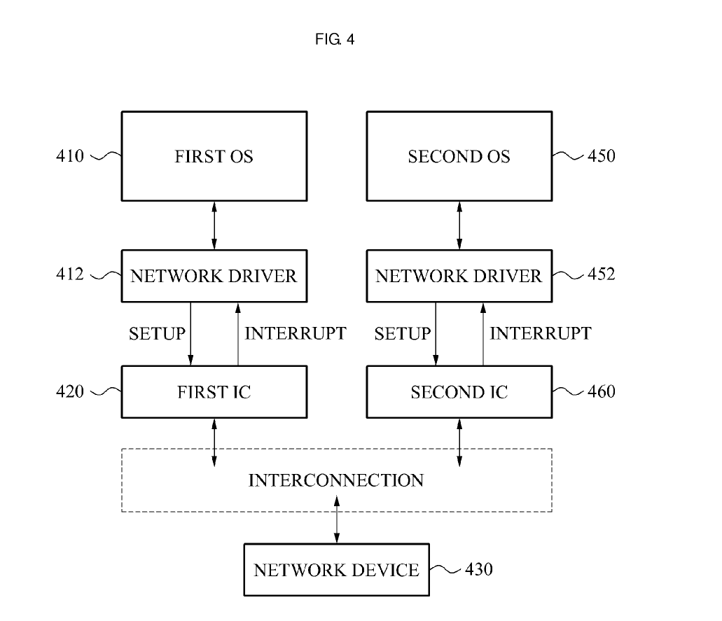

A resource holding state of the plurality of OSs may be changed as the management applications of the plurality of OSs communicate with one another. The resource may be classified into: 1) an exclusive resource partially or totally used exclusively by one OS among the plurality of OSs; or 2) a sharable resource sharable by at least one OS among the plurality of OSs. The exclusive resource may include a core and a memory of a processor. The sharable resource may include an I/O device and a network device. An example method for a management application to use the exclusive resource and the sharable resource will be described hereinafter with reference to FIGS. 3 and 4.

As described above, control of the resource allocated to each of the plurality of OSs may be performed by the management applications. Therefore, when the plurality of OSs are booted, the respective OSs may read in configuration information with respect to the entire hardware included in the electronic apparatus 100 instead of configuration information corresponding to the allocated resource. Also, the plurality of OSs may use the same configuration information with respect to the hardware included in the electronic apparatus 100. That is, common configuration information with respect to the hardware provided by the electronic apparatus 100 may be provided to each of the plurality of OSs.

According to the aforementioned structure, 1) the OS need not use a hyperviser or a virtual machine monitor for managing the resource, and 2) the OS may be executed as one OS of the plurality of OSs by being only partially revised, compared to when used as a single OS.

FIG. 3 illustrates a use method for a memory 310 of a management application, according to example embodiments.

In FIG. 3, the memory 310 is illustrated as an example of an exclusive resource. The memory 310 may be divided into at least one region. A first OS and a second OS may be included in a plurality of OSs, respectively. The second OS may be an OS other than the first OS among the plurality of OSs. In FIG. 3, a first region 312 may refer to a part of the memory 310 allocated to the first OS and a second region 314 may refer to a part of the memory 310 allocated to the second OS.

The first OS and the second OS may respectively manage a memory. A memory 320 of the first OS may indicate a memory under the control of the first OS. A memory 330 of the second OS may indicate a memory under the control of the second OS. Here, the memory 310, the memory 320 of the first OS, and the memory 330 of the second OS may correspond to the same physical memory. That is, the memory 310, the memory 320 of the first OS, and the memory 330 of the second OS may be different regions of a memory divided a plurality of regions.

The first OS may regard, as an available memory 322, a part of the memory 320 of the first OS corresponding to the first region 312 allocated to the first OS. Accordingly, the first OS may allocate the part of the memory 320 of the first OS to an application operating on the first OS. The first OS may regard a part of the memory 320 of the first OS corresponding to the second region 314 and allocated to the second OS, as a memory 324 allocated to a management application. Accordingly, the first OS may not be able to allocate the memory 324 allocated to the management application to any application operating on the first OS, other than the management application. The second region 314 may be protected from access by the first OS.

The second OS may regard, as an available memory 334, a part of the memory 330 of the second OS corresponding to the second region 314 allocated to the second OS. Accordingly, the second OS may allocate the available memory 334 to an application operating on the second OS. The second OS may regard a part of the memory 330 of the second OS corresponding to the first region 312 allocated to the first OS, as a memory 332 allocated to a management application. Accordingly, the second OS may not be able to allocate the memory 332 allocated to the management application to any application operating on the second OS, other than the management application. The first region 312 may be protected from access by the second OS.

That is, a management application of a particular OS may regard a resource held by OSs other than the particular OS among the plurality of OSs as held by the management application. Here, the resource may be the exclusive resource.

Allocation of resource as aforementioned may be changed by communication among management applications.

The first OS may hold a particular resource, by requesting the particular resource from a management application of the second OS. For example, a management application of the first OS may request a partial region of the second region 314 from the management application of the second OS. The management application of the second OS may approve the request. After the approval, the partial region may be added to the available memory 322 of the first OS. In addition, in relation to the second OS, the partial region may be added to the memory 332 allocated to the management application of the second OS.

The first OS may release holding of the particular resource held by the first OS in such a manner that the management application of the first OS returns the particular resource to the management application of the second OS. For example, the management application of the first OS may return a partial region of the first region 312 to the management application of the second OS. The management application of the second OS may approve the request. After the approval, the partial region may be added to the available memory 344 of the second OS. In addition, in relation to the first OS, the partial region may be added to the memory 324 allocated to the management application of the first OS.

As mentioned before, each management application may be allocated with a resource held by other OSs, by transmitting and receiving a message related to resource allocation with another management application, when requesting more resources from a corresponding OS. In addition, when reducing the resource allocated to the corresponding OS, the management application may return the resource to another OS by transmitting and receiving the message related to resource allocation with another management application.

A pool of resources not allocated to any particular OS may be used. For example, the management application may be allocated with a resource not allocated to any particular OS from the pool, when the corresponding OS requests more resources.

FIG. 4 illustrates a use method of a network device 430 of a management application according to example embodiments.

In FIG. 4, the network device 430 is shown as an example of a sharable resource. That is, the network device 430 is a resource that may be shared among OSs. A first OS 410 and a second OS 450 are each an OS of a plurality of OSs, respectively.

The first OS 410 may include or use a network driver 412 and the second OS 450 may include or use a network driver 452.

A first IC 420 may refer to an IC that transmits an interrupt to a processor or core executing the first OS 410. The second IC 460 may refer to an IC that transmits an interrupt to a processor or core executing the second OS 450.

An interrupt generated from the network device 430 may be transmitted to the first IC 420 and the second IC 460 through an interconnection. The interrupt transmitted to the first IC 420 may be transmitted to the first OS 410 through the network driver 412. The interrupt transmitted to the second IC 460 may be transmitted to the second OS 450 through the network driver 452.

A management application of the first OS 410 may set up the first IC 420. Information on the setup may be transmitted to the first IC 420 through the network driver 412. A management application of the second OS 450 may set up the second IC 460. Information on the setup may be transmitted to the second IC 460 through the network driver 452.

A device driver related to a sharable resource of each OS may change a holding state with respect to the sharable resource under determination by the management application.

For the OS to use the sharable resource, an interrupt needs to be transmitted to the OS from a hardware device corresponding to the sharable resource. That is, when an OS holds a sharable resource, this may mean that the interrupt generated by hardware corresponding to the sharable resource has been transmitted to the OS holding the sharable resource. Also, when the OS releases holding of the sharable resource, this may mean that transmission of the interrupt generated by the hardware corresponding to the sharable resource has been stopped. Here, holding of the sharable resource may indicate start of use of the sharable resource or installation of the resource into the OS. Release of the holding of the sharable resource may indicate a stoppage of use of the sharable resource or removal of the sharable resource from the OS.

For example, when a management application of the first OS 410 sets an interrupt of a second resource to be transmitted to the first OS 410, the first OS 410 may start use of the second resource. In addition, when the management application of the first OS 410 sets the interrupt of the second resource to not be transmitted to the first OS 410, the first OS 410 may have ended use of the second resource. When the management application of the first OS 410 sets the first IC 420, taking charge of the processor or core, to transmit the interrupt of the second resource, the first OS may start use of the second resource. When the management application of the first OS 410 sets the first IC 420 to not transmit the interrupt of the second resource, the first OS may have ended use of the second resource. Here, the second resource may be a particular sharable resource, or a resource indicating the network device 420 or another I/O device.

When the interrupt is transmitted from the second resource or a device corresponding to the second resource, the interrupt may be passed through an IC and transmitted to an OS set to use the second resource, for example the first OS 410. The OS receiving the interrupt may selectively read data related only to the OS among data related to the second resource. Here, the OS may only read the data related to the OS among the data related to the second resource, using an identifier (ID) and the like.

When the OS writes data to the device corresponding to the second resource, the OS may write the data to a buffer for the device. The buffer may be synchronized among multiple OSs. The synchronization may refer to sharing of the buffer by device drivers of the respective multiple OSs. That is, the OS may write the data to the second resource by performing synchronized data writing to the buffer for the device corresponding to the second resource. When the OS or a management application of the OS is not set to use the second resource, an error may be returned as the OS writes the data to the device corresponding to the second resource.

The OS may write data to a particular device by calling an “open( )” function or a “write( )” function with respect to a device driver of the particular device. In the OS, when an “open( )” function or a “write( )” function with respect to a driver of a device not set to be used by the OS is called, an error may be returned.

By the method described with reference to FIGS. 3 and 4, a processor may simultaneously execute a plurality of OSs and dynamically change resources allocated to the respective OSs. In addition, since the resources are managed directly by the OS and the management application, performance reduction caused by execution of a plurality of OSs may be reduced.

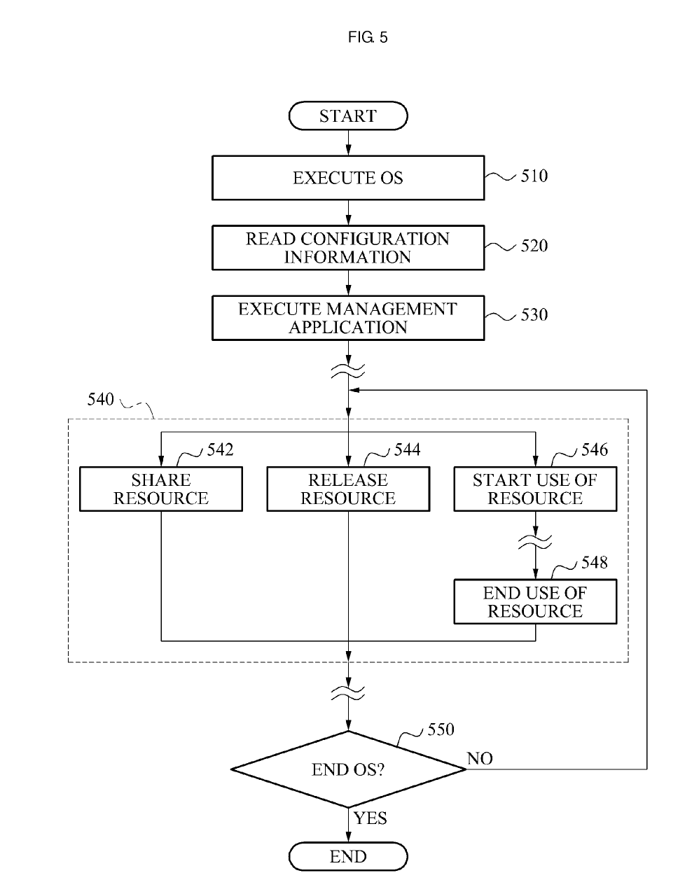

FIG. 5 illustrates an operation method of an electronic apparatus according to example embodiments.

In operation 510, a processor may execute a plurality of OSs. Here, the processor may be plural. Each of the plurality of processors may include a plurality of cores. Each of the plurality of cores may execute one OS of the plurality of OSs. An OS may be executed by at least one core.

The plurality of OSs may include at least one selected from an A/V-oriented OS designed to be appropriate for processing of audio data and video data, and a network-oriented OS designed to be appropriate for networking.

In operation 520, the plurality of OSs may read the same configuration information with respect to hardware included in the electronic apparatus.

In operation 530, the plurality of OSs may each execute a management application.

Each of the plurality of OSs may regard a resource of the electronic apparatus, held by another OS among the plurality of OSs, as used by the management application.

In operation 540, a resource holding state of each of the plurality of OSs is changed by the management application.

Operation 540 may include at least one of operation 542, operation 544, and operation 548.

Each of a first OS and a second OS may be one OS of the plurality of OSs.

In operation 542, as a management application of the first OS requests a first resource from the second OS holding the first resource, the first OS may as a result hold the first resource. The first resource may be an exclusive resource which is used exclusively by one OS among the plurality of OSs.

In operation 544, as the management application of the first OS returns the first resource to a management application of the second OS, the first OS may as a result release the holding of the first resource. Here, the second OS may be an OS other than the first OS among the plurality of OSs.

In operation 546, as the management application of the first OS sets an interrupt of the second resource to be transmitted to the first OS, the first OS may start use of the second resource. Here, the second resource may be a sharable resource which is sharable by at least one OS among the plurality of OSs.

In operation 548, as the management application of the first OS sets the interrupt of the second resource to not be transmitted to the first OS, the first OS may as a result end its use of the second resource.

In operation 550, when operation of the plurality of OSs has ended, the entire operation may be ended. Otherwise, operation 540 may be repeated.

Operations 510 to 550 illustrate example processes for executing the plurality of OSs. Therefore, various functions of the respective plurality of OSs may be performed 1) between operations 530 and 540, 2) between operations 546 and 548, and 3) between 540 and 550.

Technical features according to the example embodiments described with reference to FIGS. 1 to 4 may also be applied to the present embodiments. Therefore, a detailed description will be omitted.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts.

Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. Any one or more of the software modules described herein may be executed by a controller such as a dedicated processor unique to that unit or by a processor common to one or more of the modules. The described methods may be executed on a general purpose computer or processor or may be executed on a particular machine such as the electronic apparatus described herein.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. An electronic apparatus comprising:
a processor to execute a plurality of operating systems (OSs); and
a device,
wherein a first OS of the plurality of OSs executes a management application and the first OS regards a resource of the electronic apparatus, held by a second OS of the plurality of OSs, as being used by the management application, when the resource is held by the second OS, and
the resource corresponds to the device.

2. The electronic apparatus of claim 1, wherein the plurality of OSs use the same configuration information with respect to hardware included in the electronic apparatus.

3. The electronic apparatus of claim 1, wherein the plurality of OSs comprise at least one selected from an audio/video (A/V)-oriented OS designed for processing audio data and video data and a network-oriented OS designed for networking.

4. The electronic apparatus of claim 1, wherein each of the plurality of OSs executes a management application and a resource holding state of the plurality of OSs is changed by communication between the management applications.

5. The electronic apparatus of claim 1, wherein the first OS holds a first resource in such a manner that a management application of the first OS requests the first resource from the second OS holding the first resource.

6. The electronic apparatus of claim 5, wherein the first resource is used exclusively by one OS of the plurality of OSs.

7. The electronic apparatus of claim 1, wherein the first OS releases holding of a first resource in such a manner that a management application of the first OS returns the first resource to a management application of the second OS.

8. The electronic apparatus of claim 1, wherein the first OS starts use of a second resource in such a manner that a management application of the first OS sets an interrupt of the second resource to be transmitted to the first OS, and
the first OS ends use of the second resource in such a manner that the management application of the first OS sets the interrupt of the second resource to be not transmitted to the first OS.

9. The electronic apparatus of claim 8, wherein the second resource comprises a resource sharable by at least one OS among the plurality of OSs.

10. The electronic apparatus of claim 1, wherein
the processor comprises a plurality of cores, and
each of the plurality of cores executes one OS of the plurality of OSs.

11. An operation method of an electronic apparatus that comprises a processor and executes a plurality of operating systems (OSs), the operation method comprising:
the processor executing the plurality of OSs; and
a first OS of the plurality of OSs executing a management application,
wherein the first OS regards a resource of the electronic apparatus, held by a second OS of the plurality of OSs, as being used by the management application when the resource is held by the second OS.

12. The operation method of claim 11, further comprising the plurality of OSs reading in the same configuration information with respect to hardware included in the electronic apparatus.

13. The operation method of claim 11, wherein the plurality of OSs comprise at least one selected from an audio/video (A/V)-oriented OS designed for processing audio data and video data and a network-oriented OS designed for networking.

14. The operation method of claim 11, wherein each of the plurality of OSs executes a management application and a resource holding state of the plurality of OSs is changed by the management application.

15. The operation method of claim 14, wherein
the changing of the resource holding state comprises the first OS holding a first resource in such a manner that a management application of the first OS requests the first resource from the second OS holding the first resource.

16. The operation method of claim 15, wherein the first resource is used exclusively by one OS of the plurality of OSs.

17. The operation method of claim 14, wherein
the changing of the resource holding state comprises the first OS releasing holding of a first resource in such a manner that a management application of the first OS returns the first resource to a management application of the second OS.

18. The operation method of claim 14, wherein the changing of the resource holding state comprises:
the first OS starting use of a second resource in such a manner that a management application of the first OS sets an interrupt of the second resource to be transmitted to the first OS, and
the first OS ending use of the second resource in such a manner that the management application of the first OS sets the interrupt of the second resource to be not transmitted to the first OS.

19. The operation method of claim 11, wherein
the processor comprises a plurality of cores, and
each of the plurality of cores executes one OS of the plurality of OSs.

20. A non-transitory computer readable recording medium storing a program to cause a computer to implement the method of claim 11.

21. An electronic apparatus comprising:
a plurality of operating systems (OSs) comprising a first OS and a second OS that is different than the first OS, wherein the first OS executes a first management application;
a processor to execute the plurality of operating systems (OSs); and
a resource corresponding to a device, wherein when the resource corresponding to the device is allocated to the second OS, the first OS may set the resource as allocated to the first management application thereby preventing the resource from being allocated to other applications being executed on the first OS.
